(19) United States
(12) Patent Application Publication
(10) Pub. No.: US 2022/0001936 A1
(43) Pub. Date: Jan. 6, 2022

(54) RETENTION ASSEMBLIES FOR AUTOMOTIVE VEHICLES

(71) Applicant: FORD GLOBAL TECHNOLOGIES, LLC, Dearborn, MI (US)

(72) Inventors: Craig M. Watson, Commerce Township, MI (US); Mark A. Wisneski, Dearborn, MI (US); Martin D. Lopez, Sterling Heights, MI (US); Flondezi Godette, Saline, MI (US)

(21) Appl. No.: 16/920,838

(22) Filed: Jul. 6, 2020

(51) Int. Cl. B62D 27/06; F16B 5/06

(52) U.S. Cl. CPC B62D 27/06; F16B 5/0642; F16B 5/0664

(57) ABSTRACT

This disclosure details retention assemblies for connecting panels or other components of automotive vehicles. An exemplary retention assembly may include a polymeric panel and a combined snap assembly and fastener boss that is molded-in the polymeric panel. The retention assembly may be utilized to connect an additional structure, such an another panel, to the polymeric panel for establishing a vehicle assembly. The combined snap assembly and fastener boss packages both snap and fastening features within a common packaging space of the retention assembly, thereby reducing assembly complexities and costs.

### TECHNICAL FIELD

This disclosure relates to automotive vehicles, and more particularly to retention assemblies that include a combined snap assembly and fastener boss for connecting together vehicle panels or other parts.

### BACKGROUND

Motor vehicles include a multitude of components that must be located, supported, and attached relative to one another during vehicle assembly. Various locators, fasteners, snaps, etc. are commonly employed for achieving the locating, supporting, and attaching of components. Avoidance of motion and squeak between the connected vehicle components must be balanced against a limited amount of packaging space for accommodating the locators, fasteners, and/or snaps within modern automotive vehicle designs.

### SUMMARY

A retention assembly according to an exemplary aspect of the present disclosure includes, among other things, a polymeric panel and a combined snap assembly and fastener boss formed in the polymeric panel.

In a further non-limiting embodiment of the foregoing retention assembly, the combined snap assembly and fastener boss is a molded-in feature of the polymeric panel.

In a further non-limiting embodiment of either of the foregoing retention assemblies, the combined snap assembly and fastener boss protrudes outwardly from an exterior surface of the polymeric panel and includes both a snap assembly and a fastener boss.

In a further non-limiting embodiment of any of the foregoing retention assemblies, the snap assembly includes a first arm, a second arm, and an open ended slot separating the first and second arms.

In a further non-limiting embodiment of any of the foregoing retention assemblies, the first arm and the second arm cooperate to establish a two-way locator configured for locating a separate structure relative to the polymeric panel.

In a further non-limiting embodiment of any of the foregoing retention assemblies, each of the first arm and the second arm includes an interior surface and an exterior surface. The exterior surface includes a first sloped wall, a second sloped wall extending at a transverse angle relative to the first sloped wall, and a lip disposed between the first sloped wall and the second sloped wall.

In a further non-limiting embodiment of any of the foregoing retention assemblies, the fastener boss includes a bore that bisects the open ended slot near a midpoint of the snap assembly.

In a further non-limiting embodiment of any of the foregoing retention assemblies, the bore is established by a first scallop formed in the first arm, a second scallop formed in the second arm, and the slot.

In a further non-limiting embodiment of any of the foregoing retention assemblies, the snap assembly includes a plurality of spaced apart prongs that are arranged circumferentially relative to one another to establish a locating pin that protrudes from the exterior surface.

In a further non-limiting embodiment of any of the foregoing retention assemblies, the fastener boss includes a bore that bisects the locating pin.

In a further non-limiting embodiment of any of the foregoing retention assemblies, the locating pin is a four-way locator configured for locating a separate structure relative to the polymeric panel.

In a further non-limiting embodiment of any of the foregoing retention assemblies, each of the plurality of spaced apart prongs includes an interior surface and an exterior surface. The exterior surface includes a first sloped wall, a second sloped wall, and a lip disposed between the first sloped wall and the second sloped wall.

In a further non-limiting embodiment of any of the foregoing retention assemblies, the retention assembly includes a top hat formed on a separate structure that is attachable to the polymeric panel via the combined snap assembly and fastener boss.

In a further non-limiting embodiment of any of the foregoing retention assemblies, a mechanical fastener is received within a bore of a fastener boss of the combined snap assembly and fastener boss.

In a further non-limiting embodiment of any of the foregoing retention assemblies, the snap assembly of the combined snap assembly and fastener boss is received through an elongated slot or a circular hole formed in a separate structure that is attachable to the polymeric panel.

A vehicle assembly according to another exemplary aspect of the present disclosure includes, among other things, a first panel, a separate structure connectable to the first panel, and a retention assembly configured to locate and connect the separate structure to the first panel. The retention assembly includes a combined snap assembly and fastener boss formed in the first panel.

In a further non-limiting embodiment of the foregoing vehicle assembly, the first panel is a polymeric panel and the separate structure is a polymeric or metallic structure.

In a further non-limiting embodiment of either of the foregoing vehicle assemblies, the first panel and the combined snap assembly and fastener boss establish a unitary, integrally formed polymeric structure.

In a further non-limiting embodiment of any of the foregoing vehicle assemblies, the retention assembly includes a mechanical fastener received within a bore of a fastener boss of the combined snap assembly and fastener boss.

In a further non-limiting embodiment of any of the foregoing vehicle assemblies, the retention assembly includes a top hat formed on the separate structure.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 is a front perspective view of an automotive vehicle.

FIG. 2 is an exploded view of an exemplary retention assembly.

FIG. 3 is a side view of the retention assembly of FIG. 2.

FIG. 4 is a perspective, cross-sectional view of the retention assembly of FIG. 2.

FIG. 5 is a side, cross-sectional view of the retention assembly of FIG. 2.

FIG. 6 schematically illustrates various design characteristics of the retention assembly of FIG. 2.

FIG. 7 is an exploded view of another exemplary retention assembly.

FIG. 8 is a perspective, cross-sectional view of the retention assembly of FIG. 7.

FIG. 9 is a side, cross-sectional view of the retention assembly of FIG. 7.

FIG. 10 is an exploded view of another exemplary retention assembly.

FIG. 11 is a side view of the retention assembly of FIG. 10.

FIG. 12 is a perspective, cross-sectional view of the retention assembly of FIG. 10.

FIG. 13 is a side, cross-sectional view of the retention assembly of FIG. 10.

FIG. 14 schematically illustrates various design characteristics of the retention assembly of FIG. 10.

FIG. 15 is an exploded view of another exemplary retention assembly.

FIG. 16 is a perspective, cross-sectional view of the retention assembly of FIG. 15.

FIG. 17 is a side, cross-sectional view of the retention assembly of FIG. 15.

FIG. 18 is an exploded view of yet another exemplary retention assembly.

FIG. 19 is a side view of the retention assembly of FIG. 18.

FIG. 20 is a perspective, cross-sectional view of the retention assembly of FIG. 18.

FIG. 21 is a side, cross-sectional view of the retention assembly of FIG. 18.

FIG. 22 schematically illustrates various design characteristics of the retention assembly of FIG. 18.

### DETAILED DESCRIPTION

This disclosure details retention assemblies for connecting panels or other components of automotive vehicles. An exemplary retention assembly may include a polymeric panel and a combined snap assembly and fastener boss that is molded-in the polymeric panel. The retention assembly may be utilized to connect an additional structure, such an another panel, to the polymeric panel for establishing a vehicle assembly. The combined snap assembly and fastener boss packages both snap and fastening features within a common packaging space of the retention assembly, thereby reducing assembly complexities and costs. These and other features of this disclosure are described in greater detail below.

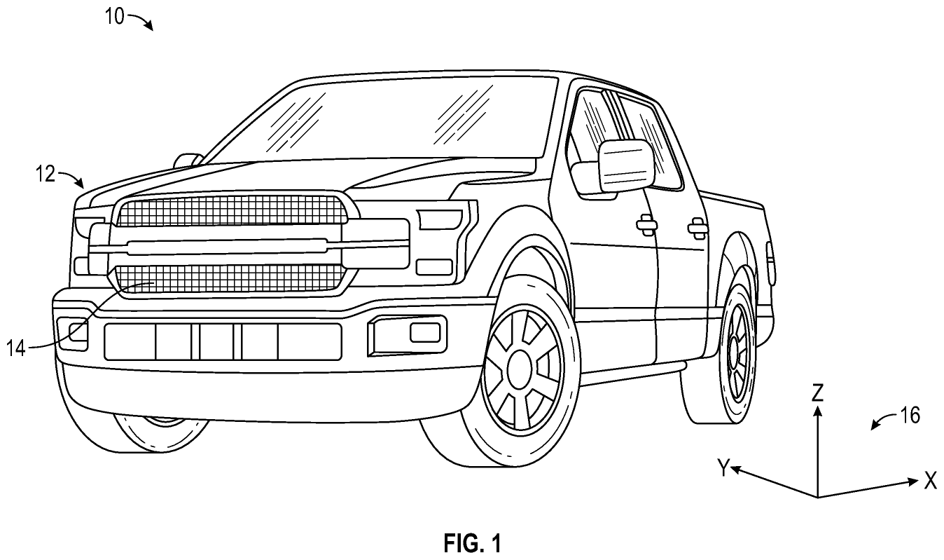

FIG. 1 illustrates a vehicle 10, which in this embodiment is a pickup truck. While a pickup truck is shown in FIG. 1, this disclosure extends to various other types of vehicles including sport utility vehicles (SUVs), crossovers, cars, vans, or any other type of automotive vehicle. The vehicle 10 could also be a conventional motor vehicle, a battery powered hybrid or electric vehicle, or an autonomous vehicle (i.e., a driverless vehicle).

Although a specific component relationship is illustrated in the figures of this disclosure, the illustrations are not intended to limit this disclosure. The placement and orientation of the various components of the vehicle 10 are shown schematically and could vary within the scope of this disclosure. In addition, the various figures accompanying this disclosure are not necessarily to scale, and some features may be exaggerated or minimized to emphasize certain details of a particular component.

The vehicle 10 includes a vehicle body 12. The vehicle body 12 may include multiple panels or other components that are located, supported, and attached to one another to form vehicle assemblies that are part of the vehicle body 12. By way of one non-limiting example, a grille 14 may be located, supported, and/or attached to a housing/carrier or a front end structural component for establishing a front end assembly of the vehicle body 12. Other exemplary vehicle assemblies that are part of the vehicle body 12 include, but are not limited to, fascia-to-fender/body side vehicle assemblies, license plate mounting bracket-to-structural component vehicle assemblies, spoiler-to-structural component vehicle assemblies, side mirror-to-body side vehicle assemblies, etc.

The vehicle 10 of FIG. 1 is shown relative to a three dimensional Cartesian coordinate system 16 that generally orients the vehicle 10 relative to X, Y, and Z axis directions. Axis line X generally represents an X-axis direction along a length of the vehicle 10, the axis line Y generally represents a Y-axis direction across a width of the vehicle 10, and the axis line Z generally represents a Z-axis direction along a height of the vehicle 10. Reference may be made periodically throughout this specification to the X-axis, the Y-axis, and the Z-axis directions. These directions coincide with the X, Y, and Z axes indicated by the Cartesian coordinate system 16 shown in FIG. 1.

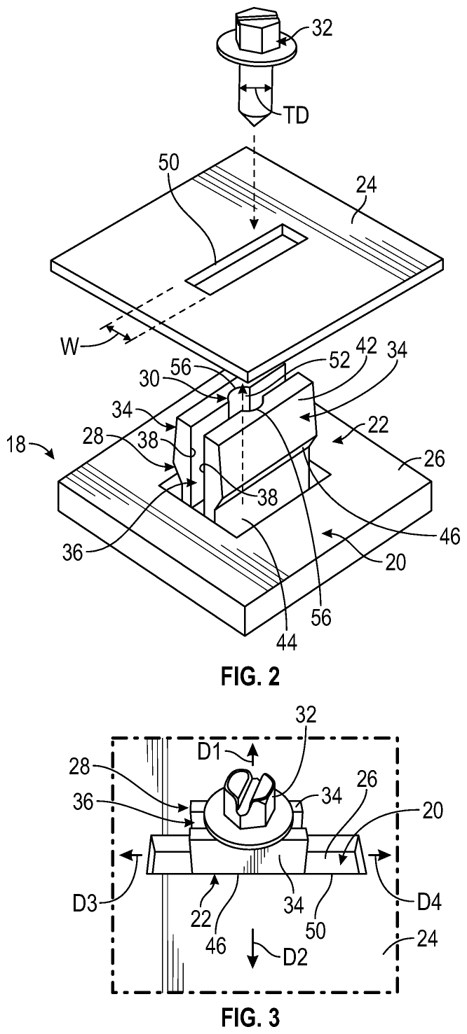

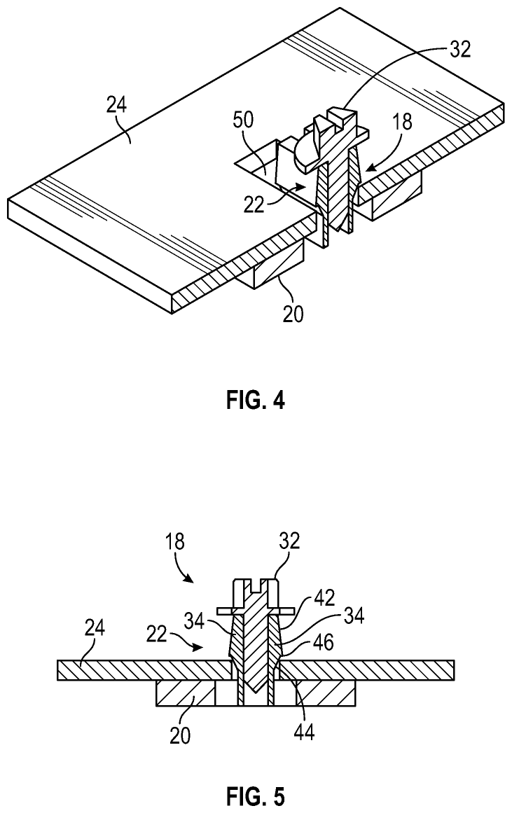

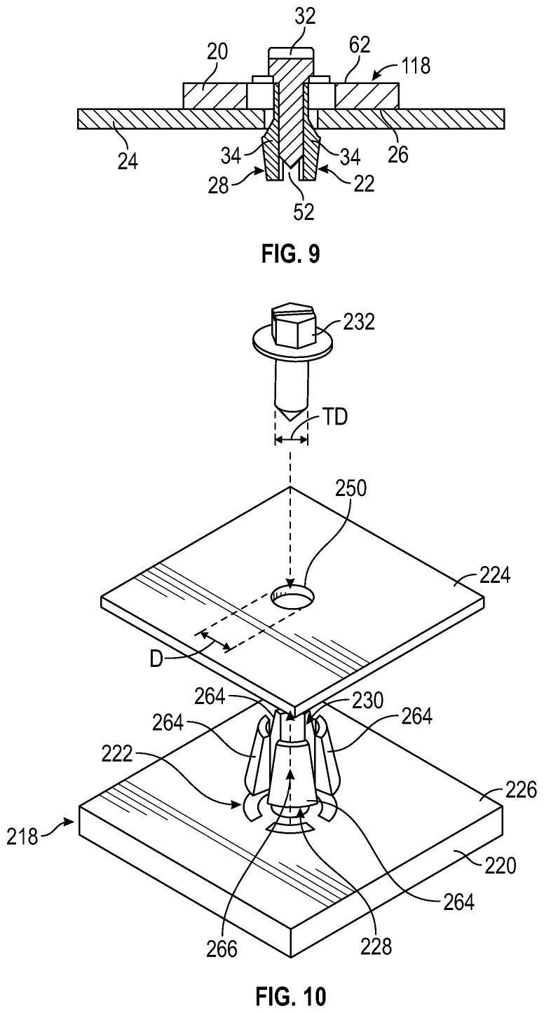

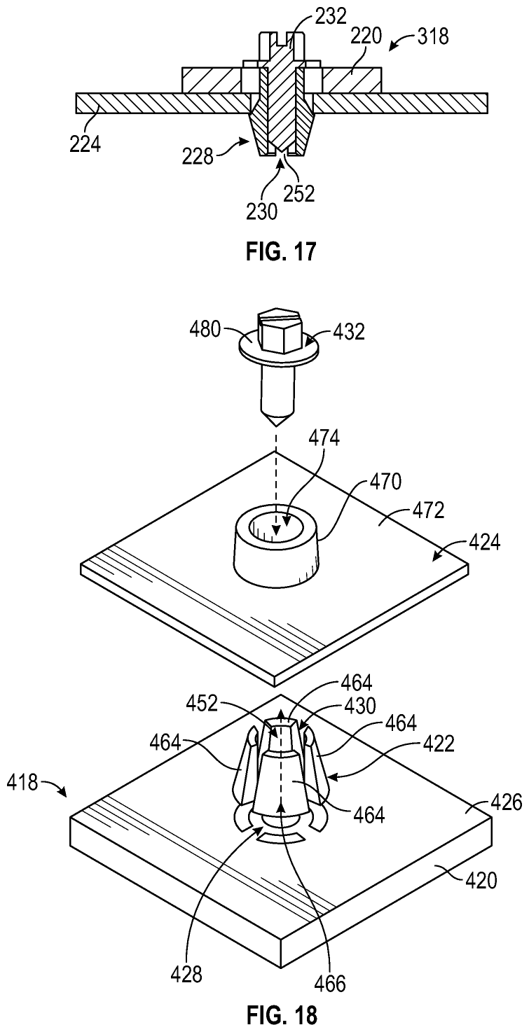

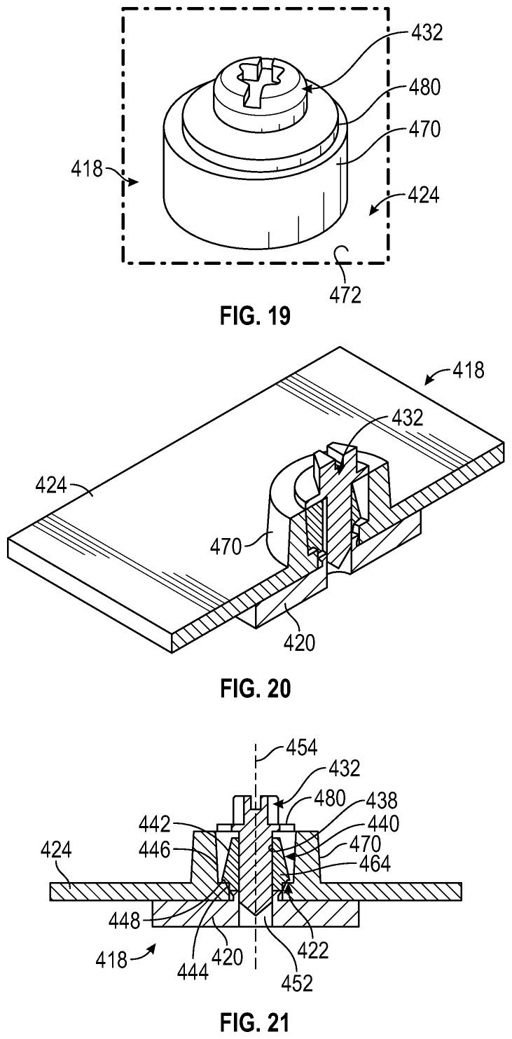

The vehicle 10 is referenced herein to describe exemplary embodiments of retention assemblies that can be used to locate and connect vehicle panels while maintaining consistent margins and flushness between the panels, thereby simplifying assembly and reducing costs. Exemplary retention assemblies are described in further detail below with reference to FIGS. 2-22. Although the retention assemblies of this disclosure are shown and described with reference to the vehicle 10, this disclosure is not limited specifically to vehicle retention assemblies and could extend to any other industry that may benefit from mechanical connections. Stated another way, the retention assemblies of this disclosure could be employed for connecting components within any industrial application.

FIGS. 2, 3, 4, 5, and 6 illustrate a retention assembly 18 according to a first exemplary embodiment of this disclosure. The retention assembly 18 may include a polymeric panel 20 and a combined snap assembly and fastener boss 22. In an embodiment, the combined snap assembly and fastener boss 22 is a molded-in feature of the polymeric panel 20. Thus, the polymeric panel 20 and the combined snap assembly and fastener boss 22 establish a unitary, integrally formed polymeric structure of the retention assembly 18. The specific polymer make-up of the retention assembly 18 is not intended to limit this disclosure.

The retention assembly 18 may be used to locate, secure, support, and/or attach a separate structure 24 to the polymeric panel 20. The separate structure 24 may be an additional panel or some other part or component. The separate structure 24 may be either a metallic part or a polymeric part. In an embodiment, the separate structure 24 is made of a similar material as the retention assembly 18. In another embodiment, the separate structure 24 is made of a different material from the retention assembly 18. Once connected, the retention assembly 18 and the separate structure 24 may establish a vehicle assembly of the vehicle body 12 of the vehicle 10 of FIG. 1, for example.

The polymeric panel 20 and the separate structure 24 may each optionally include a surface finish. For example, the polymeric panel 20 and the separate structure 24 could include a chrome finish, a painted finish, or any other type of surface finish. The surface finish of the polymeric panel 20 could be either the same as or different from the surface finish of the separate structure 24.

The combined snap assembly and fastener boss 22 may protrude outwardly from an exterior surface 26 of the polymeric panel 20 and may include both a snap assembly 28 and a fastener boss 30. The snap assembly 28 and the fastener boss 30 may therefore be provided within a common packaging space of the retention assembly 18 rather than separately from one another.

The snap assembly 28 is adapted to locate and snap-connect the separate structure 24 and the polymeric panel 20. The snap assembly 28 may further provide for a hands-free feature during assembly in which the separate structure 24 may be connected to the polymeric panel 20 prior to driving a positive attachment. The fastener boss 30 is adapted to receive a mechanical fastener 32 (e.g., a bolt, screw, etc.) for establishing the positive attachment between the separate structure 24 and the polymeric panel 20, such as to prevent relative motion between these parts and any associated rattle or squeak that may be caused by the relative motion. Therefore, the mechanical fastener 32 may be considered an optional feature of the retention assembly 18 since this component can be eliminated in certain situations in which squeak mitigation is not required.

The snap assembly 28 may include a pair of legs 34 that protrude outwardly from the exterior surface 26 of the polymeric panel 20. The legs 34 may be spaced apart from one another to establish a slot 36 therebetween.

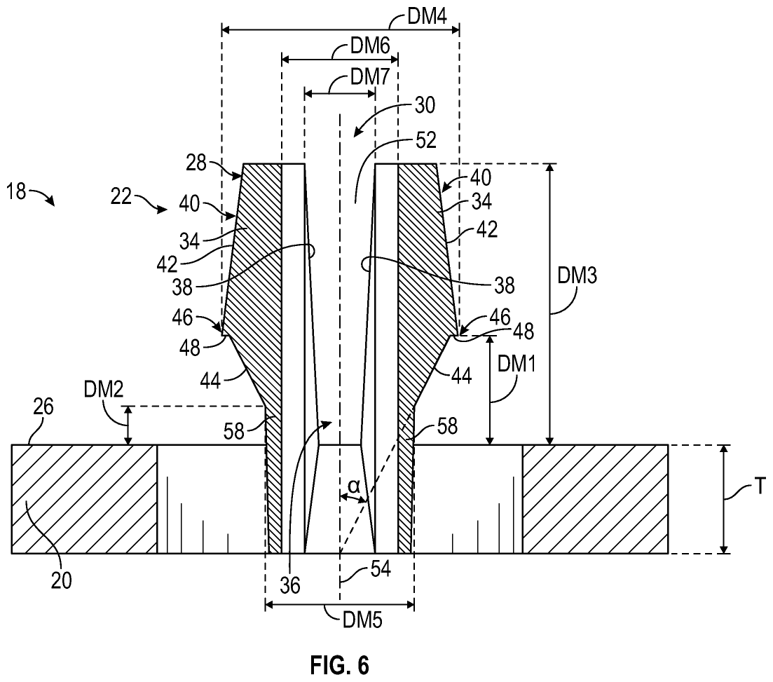

In an embodiment, each leg 34 includes an arrowhead shape. However, other shapes are contemplated within the scope of this disclosure. Each leg 34 includes an interior surface 38 and an exterior surface 40. The interior surfaces 38 of the legs 34 face toward one another and partially bound the slot 36. The interior surfaces 38 may be substantially flat surfaces. The exterior surfaces 40 may be non-flat surfaces that include at least a first sloped wall 42, a second sloped wall 44, and a lip 46 between the first sloped wall 42 and the second sloped wall 44 (best shown in FIG. 6). The second sloped wall 44 may extend at a transverse angle relative to the first sloped wall 42. The lip 46 may include a flat surface 48.

The separate structure 24 may include an opening 50 for receiving the legs 34 of the snap assembly 28. In an embodiment, the opening 50 is an elongated slot. The separate structure 24 may be positioned over the legs 34 and moved toward the polymeric panel 20 for snap-connecting the separate structure 24 to the polymeric panel 20. Once snapped into place, the separate structure 24 is received within the space extending between the polymeric panel 20 and the flat surfaces 48 of the lips 46. The lips 46 thereby prevent the separate structure 24 from undesirably becoming displaced from the polymeric panel 20.

The snap assembly 28 functions as a two-way locator for locating the separate structure 24 relative to the polymeric panel 20. For example, once the separate structure 24 is received over the legs 34 of the snap assembly 28, the legs 34 of the snap assembly 28 may restrict movement in directions D1, D2 while permitting a small amount of movement in directions D3, D4 (see FIG. 3). The snap assembly 28 can be configured such that the directions D1, D2 in which movement is restricted extend along the X-axis, Y-axis, or Z-axis.

The slot 36 may be an elongated slot. In an embodiment, the slot 36 is open ended at each opposing end of the snap assembly 28. Therefore, the legs 34 of the snap assembly 28 may be slightly flexible and do not contact one another.

As best illustrated in FIGS. 2 and 6, the fastener boss 30 may include a bore 52 that extends through the snap assembly 28 along a central longitudinal axis 54. The bore 52 may bisect the slot 36 near a midpoint of the snap assembly 28. A scallop 56 may be formed in the interior surface 38 of each leg 34 of the snap assembly 28. The scallops 56 and the slot 36 cooperate to establish the bore 52 of the fastener boss 30. The mechanical fastener 32 may be inserted through the bore 52 of the fastener boss 30 for applying a clamping load across the assembly of the polymeric panel 20 and the separate structure 24. In this embodiment, the mechanical fastener 32 may be inserted through the opening 50 of the separate structure 24 and then into the bore 52 for applying the clamping load.

Referring now primarily to FIG. 6, various design characteristics associated with the combined snap assembly and fastener boss 22 may be scalable for accommodating varying size and shape ranges of the polymeric panel 20 and the separate structure 24. Various angles, dimensions, and ratios associated with the features of the combined snap assembly and fastener boss 22 are described below. These design characteristics are non-limiting examples of characteristics of an exemplary retention assembly and are not intended to limit this disclosure.

The second sloped wall 44 of each leg 34 may extend at an angle a relative to the central longitudinal axis 54 of the bore 52. In an embodiment, the angle a is about 30°. In this disclosure, the term “about” means that the expressed quantities or ranges need not be exact but may be approximated and/or larger or smaller, reflecting acceptable tolerances, conversion factors, measurement error, etc.

The flat surface 48 of the lip 46 of each leg 34 may be positioned at a first dimension DM1 (e.g., a first distance) above the exterior surface 26 of the polymeric panel. In an embodiment, the first dimension DM1 is between about 125% and about 150% of a thickness T of the polymeric panel 20. In another embodiment, the first dimension DM1 is about 143% of the thickness T. The combination of the angle a and the first dimension DM1 relative to the thickness T are important design criteria for accommodating part variations between the polymeric panel 20 and the separate structure 24.

A base 58 of each leg 34 connects the legs 34 of the snap assembly 28 to the polymeric panel 20. The base 58 may extend between the exterior surface 26 of the polymeric panel 20 and the second sloped wall 44. The base 58 may extend a second dimension DM2 (e.g., a second distance) above the exterior surface 26 of the polymeric panel 20. In an embodiment, the second dimension DM2 is between about 40% and about 50% of the thickness T of the polymeric panel 20. In another embodiment, the second dimension DM2 is about 43% of the thickness T.

The legs 34 of the snap assembly 22 may extend a third dimension DM3 (e.g., a third distance) above the exterior surface 26 of the polymeric panel 20. In an embodiment, the third dimension DM3 is a factor of between about 3 and about 4 times the thickness T of the polymeric panel 20. In another embodiment, the third dimension DM3 is about 325% of the thickness T.

A fourth dimension DM4 (e.g., a fourth distance) may extend between outer surfaces of the lips 46 of the legs 34 of the snap assembly 28. In an embodiment, the fourth dimension DM4 is between about 105% and 130% of a width W (see FIG. 2) of the opening 50 of the separate structure 24. In another embodiment, the fourth dimension DM4 is about 125% of the width W of the opening 50.

A fifth dimension DM5 (e.g., a fifth distance) may extend between outer surfaces of the bases 58 of the legs 34 of the snap assembly 28. In an embodiment, the fifth dimension DM5 is between about 60% and about 80% of the width W of the opening 50 of the separate structure 24. In another embodiment, the fifth dimension DM5 is about 70% of the width W of the opening 50. In yet another embodiment, the fifth dimension DM5 is about 110% of a thread dimeter TD (see FIG. 2) of the mechanical fastener 32.

A sixth dimension DM6 (e.g., a sixth distance) may extend between the walls of the scallops 56 of the legs 34 of the snap assembly 28. The sixth dimension DM6 thus corresponds to a diameter of the bore 52 of the fastener boss 30. In an embodiment, the sixth dimension DM6 is between about 80% and about 90% of the thread diameter TD of the mechanical fastener 32. In another embodiment, the sixth dimension DM6 is about 87% of the thread dimeter TD of the mechanical fastener 32.

A seventh dimension DM7 may extend between the interior surfaces 38 of the legs 34 of the snap assembly 28. In an embodiment, the seventh dimension DM7 is between about 40% and about 50% of the thread diameter TD of the mechanical fastener 32. In another embodiment, the seventh dimension DM7 is about 48% of the thread diameter TD of the mechanical fastener 32.

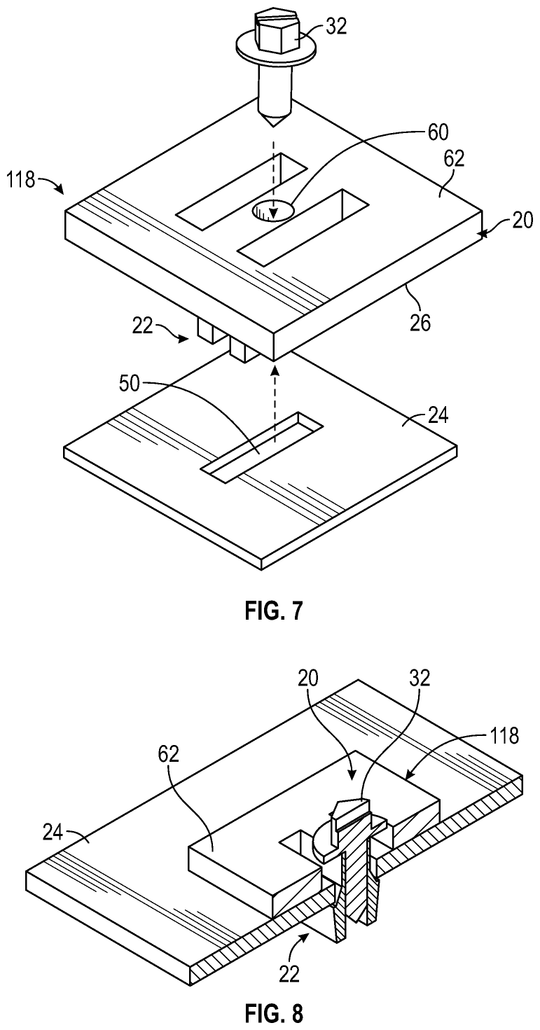

FIGS. 7, 8, and 9 illustrate a retention assembly 118 according to a second exemplary embodiment of this disclosure. The retention assembly 118 is similar to the retention assembly 18 described above but includes an “inverted design” in which the polymeric panel 20 with the combined snap assembly and fastener boss 22 is located and attached relative to the separate structure 24. In this embodiment, the snap assembly 28 is inserted through the opening 50 of the separate structure 24 to locate and snap-connect the polymeric panel 20 to the separate structure 24. A mechanical fastener 32 may then be inserted through an outer opening 60 of the bore 52 of the fastener boss 30 and then into the bore 52 for applying a clamping load across the assembly of the polymeric panel 20 and the separate structure 24. In this embodiment, the outer opening 60 is formed in an exterior surface 62 of the polymeric panel 20 that is located opposite from the exterior surface 26 from which the combined snap assembly and fastener boss 22 protrudes.

FIGS. 10, 11, 12, 13, and 14 illustrate a retention assembly 218 according to a third exemplary embodiment of this disclosure. The retention assembly 218 may include a polymeric panel 220 and a combined snap assembly and fastener boss 222. In an embodiment, the combined snap assembly and fastener boss 222 is a molded-in feature of the polymeric panel 220.

The retention assembly 218 may be used to locate, support, and/or attach a separate structure 224 to the polymeric panel 220. Once connected, the retention assembly 218 and the separate structure 224 may establish a vehicle assembly of the vehicle body 12 of the vehicle 10 of FIG. 1, for example.

The combined snap assembly and fastener boss 222 may protrude outwardly from an exterior surface 226 of the polymeric panel 220 and may include both a snap assembly 228 and a fastener boss 230. The snap assembly 228 is adapted to locate and snap-connect the separate structure 224 and the polymeric panel 220. The fastener boss 230 is adapted to receive a mechanical fastener 232 for establishing a positive attachment between the separate structure 224 and the polymeric panel 220, such as to prevent relative motion between these parts and any associated rattle or squeak that may be caused by the relative motion. Therefore, the mechanical fastener 232 may be considered an optional feature of the retention assembly 218 since this component can be eliminated in certain situations in which squeak mitigation is not required.

The snap assembly 228 may include a plurality of prongs 264 that protrude outwardly from the exterior surface 226 of the polymeric panel 20. The prongs 264 may be spaced apart and arranged circumferentially relative to one another to establish a locating pin 266 of the snap assembly 228. Therefore, the prongs 264 may be slightly flexible and do not contact one another. In an embodiment, the locating pin 266 is made up of four prongs 264. However, a greater or fewer number of prongs 264 could be utilized to construct the locating pin 266.

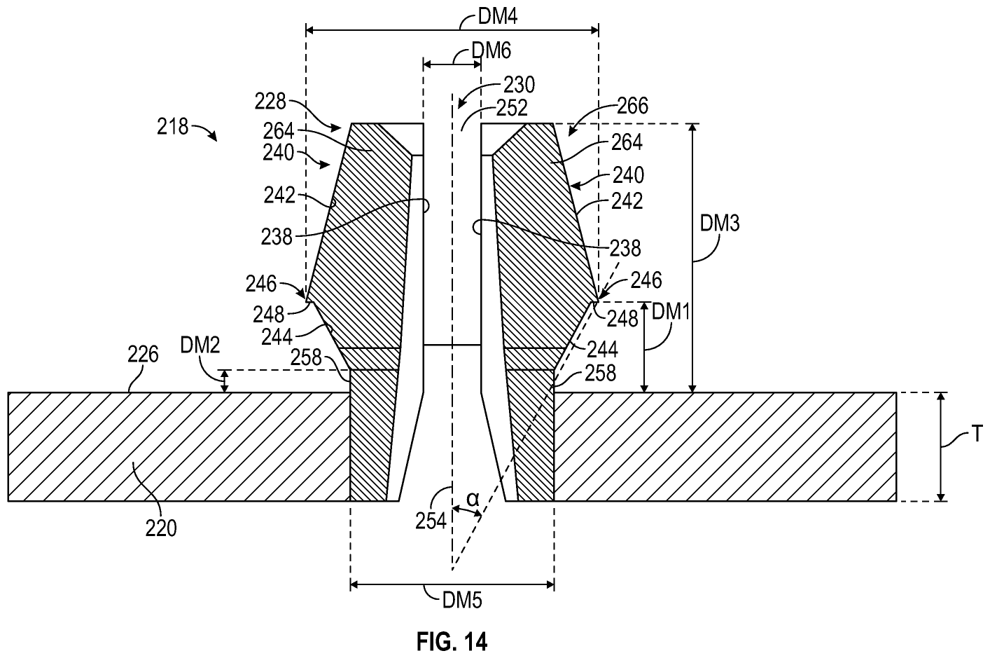

Each prong 264 includes an interior surface 238 and an exterior surface 240. The interior surface 238 of each prong 264 faces toward an interior surface 238 of at least one other prong 264. The interior surfaces 238 may be substantially flat surfaces. The exterior surfaces 240 may be non-flat surfaces that include at least a first sloped wall 242, a second sloped wall 244, and a lip 246 between the first sloped wall 242 and the second sloped wall 244 (best shown in FIG. 14). The second sloped wall 244 may extend at a transverse angle relative to the first sloped wall 242. The lip 246 may include a flat surface 248.

The separate structure 224 may include an opening 250 for receiving the locating pin 266 of the snap assembly 228. In an embodiment, the opening 250 is a round hole. The separate structure 224 may be positioned over the locating pin 266 and moved toward the polymeric panel 220 for snap-connecting the separate structure 224 to the polymeric panel 220. Once snapped into place, the separate structure 224 is received within the space extending between the polymeric panel 220 and the flat surfaces 248 of the lips 246. The lips 246 thereby prevent the separate structure 224 from undesirably becoming displaced from the polymeric panel 220.

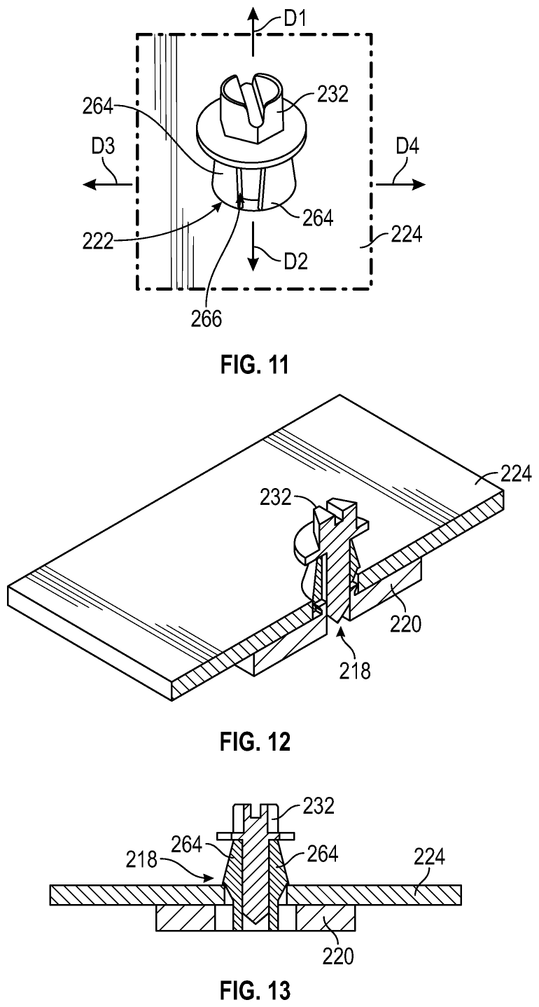

The locating pin 266 of the snap assembly 228 may function as a four-way locator for locating the separate structure 224 relative to the polymeric panel 220. For example, once the separate structure 224 is received over the locating pin 266 of the snap assembly 228, the prongs 264 of the locating pin 266 may restrict movement in directions D1, D2, D3, and D4 (see FIG. 11). The snap assembly 228 may be configured such that the directions D1, D2, D3, and D4 in which movement is restricted extend along any two axes of the X-axis, Y-axis, and Z-axis.

As best illustrated in FIGS. 10 and 14, the fastener boss 230 may include a bore 252 that extends through the snap assembly 228 along a central longitudinal axis 254. The bore 252 may bisect the locating pin 266 and is therefore circumscribed by the prongs 264. The mechanical fastener 232 may be inserted through the bore 252 of the fastener boss 230 for applying a clamping load across the assembly of the polymeric panel 220 and the separate structure 224. In this embodiment, the mechanical fastener 232 may be inserted through the opening 250 and then into the bore 252 for applying the clamping load.

Referring now primarily to FIG. 14, various design characteristics associated with the combined snap assembly and fastener boss 222 may be scalable for accommodating varying sizes and shapes of the polymeric panel 220 and the separate structure 224. Various angles, dimensions, ratios, etc. associated with the features of the combined snap assembly and fastener boss 222 are described below. Again, these design characteristics are non-limiting examples of characteristics of an exemplary retention assembly and are not intended to limit this disclosure.

The second sloped wall 244 of each prong 266 may extend at an angle a relative to the central longitudinal axis 254 of the bore 252. In an embodiment, the angle a is about 30°.

The flat surface 248 of the lip 246 of each prong 264 may be positioned at a first dimension DM1 (e.g., a first distance) above the exterior surface 226 of the polymeric panel 220. In an embodiment, the first dimension DM1 is between about 110% and about 125% of a thickness T of the polymeric panel 220. In another embodiment, the first dimension DM1 is about 115% of the thickness T. The combination of the angle a and the first dimension DM1 relative to the thickness T are important design criteria for accommodating part variations between the polymeric panel 220 and the separate structure 224.

A base 258 of each prong 264 connects the prongs 264 of the snap assembly 228 to the polymeric panel 220. Each base 258 may extend between the exterior surface 226 of the polymeric panel 220 and the second sloped wall 244. The base 258 may extend a second dimension DM2 (e.g., a second distance) above the exterior surface 226 of the polymeric panel 220. In an embodiment, the second dimension D2 is between about 20% and about 40% of the thickness T of the polymeric panel 220. In another embodiment, the second dimension DM2 is about 28% of the thickness T.

Each prong 264 may extend a third dimension DM3 (e.g., a third distance) above the exterior surface 226 of the polymeric panel 220. In an embodiment, the third dimension D3 is a factor of between about 3 and about 4 times the thickness T of the polymeric panel 220. In another embodiment, the third dimension DM3 is about 325% of the thickness T.

A fourth dimension DM4 (e.g., a fourth distance) may extend between outer surfaces of the lips 246 of opposing prongs 266 of the snap assembly 228. In an embodiment, the fourth dimension DM4 is between about 105% and 130% of a Diameter D (see FIG. 10) of the opening 250 of the separate structure 224. In another embodiment, the fourth dimension DM4 is about 125% of the diameter D of the opening 250.

A fifth dimension DM5 (e.g., a fifth distance) may extend between outer surfaces of the bases 258 of opposing prongs 264 of the snap assembly 228. In an embodiment, the fifth dimension DM5 is between about 60% and about 80% of the diameter D of the opening 250. In another embodiment, the fifth dimension DM5 is about 75% of the diameter D of the opening 250. In yet another embodiment, the fifth dimension DM5 is about 143% of a thread dimeter TD (see FIG. 10) of the mechanical fastener 232.

A sixth dimension DM6 (e.g., a sixth distance) may extend between the interior surfaces 238 of opposing prongs 264 of the snap assembly 28. The sixth dimension DM6 thus corresponds to a diameter of the bore 252 of the fastener boss 230. In an embodiment, the sixth dimension DM6 is between about 80% and about 90% of the thread diameter TD of the mechanical fastener 232. In another embodiment, the sixth dimension DM6 is about 87% of the thread dimeter TD of the mechanical fastener 232.

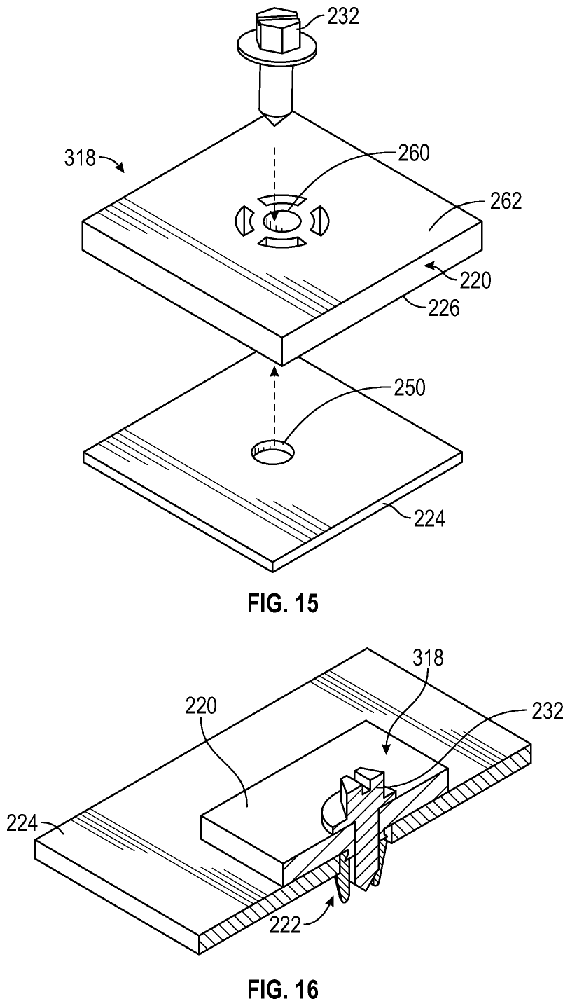

FIGS. 15, 16, and 17 illustrate a retention assembly 318 according to a fourth exemplary embodiment of this disclosure. The retention assembly 318 is similar to the retention assembly 218 described above but includes an “inverted design” in which the polymeric panel 220 with the combined snap assembly and fastener boss 222 is located and attached relative to the separate structure 224. In this embodiment, the snap assembly 228 is inserted through the opening 250 of the separate structure 224 to locate and snap-connect the polymeric panel 220 to the separate structure 224. A mechanical fastener 232 may then be inserted through an outer opening 260 of the bore 252 of the fastener boss 230 and then into the bore 252 for applying a clamping load across the assembly of the polymeric panel 220 and the separate structure 224. In this embodiment, the outer opening 260 is formed in an exterior surface 262 of the polymeric panel 220 that is located opposite from the exterior surface 226 from which the combined snap assembly and fastener boss 222 protrudes.

FIGS. 18, 19, 20, 21, and 22 illustrate a retention assembly 418 according to a fifth exemplary embodiment of this disclosure. The retention assembly 418 may include a polymeric panel 420 having a combined snap assembly and fastener boss 422, and a separate structure 424 having a top hat 470. In an embodiment, the combined snap assembly and fastener boss 422 is a molded-in feature of the polymeric panel 420, and the top hat 470 is a molded-in feature of the separate structure 424.

The retention assembly 418 may be used to locate, secure, and/or attach the separate structure 424 to the polymeric panel 420. Once connected, the polymeric panel 420 and the separate structure 424 may establish a vehicle assembly of the vehicle body 12 of the vehicle 10 of FIG. 1, for example.

The combined snap assembly and fastener boss 422 may protrude outwardly from an exterior surface 426 of the polymeric panel 420 and may include both a snap assembly 428 and a fastener boss 430. The snap assembly 428 is adapted to locate and snap-connect the separate structure 424 and the polymeric panel 420. The fastener boss 430 is adapted to receive a mechanical fastener 432 for establishing a positive attachment between the separate structure 424 and the polymeric panel 420, such as to prevent relative motion between these parts and any associated rattle or squeak that may be caused by the relative motion. Therefore, the mechanical fastener 432 may be considered an optional feature of the retention assembly 418 since this component can be eliminated in certain situations in which squeak mitigation is not required.

The snap assembly 428 may include a plurality of prongs 464 that protrude outwardly from the exterior surface 426 of the polymeric panel 420. The prongs 464 may be spaced apart and arranged circumferentially relative to one another to establish a locating pin 466 of the snap assembly 428. Therefore, the prongs 464 may be slightly flexible and do not contact one another. In an embodiment, the locating pin 466 is made up of four prongs 464. However, a greater or fewer number of prongs 464 could be utilized to construct the locating pin 466.

Each prong 464 includes an interior surface 438 and an exterior surface 440. The interior surface 438 of each prong 464 faces toward the interior surface 438 of at least one other prong 464. The interior surfaces 438 may be substantially flat surfaces. The exterior surfaces 440 may be non-flat surfaces that include at least a first sloped wall 442, a second sloped wall 444, and a lip 446 between the first sloped wall 442 and the second sloped wall 444. The second sloped wall 444 may extend at a transverse angle relative to the first sloped wall 442. The lip 446 may include a flat surface 448.

The top hat 470 may protrude from an exterior surface 472 of the separate structure 424 and may establish a passageway 474 that aligns with an opening 450 of the separate structure 424. The top hat 470 may circumscribe the opening 450 and is configured to accommodate portions of the locating pin 466 of the snap assembly 428. In an embodiment, the opening 450 is a round hole, and the passageway 474 is a tapered passageway that connects with the opening 450. The separate structure 424 may be positioned over the locating pin 466 and moved toward the polymeric panel 420 for snap-connecting the separate structure 424 to the polymeric panel 420. Once snapped into place, the locating pin 466 is received through the opening 450 and within the passageway 474 of the top hat 470. The locating pin 466 of the snap assembly 428 may function as a four-way locator for locating the separate structure 424 relative to the polymeric panel 420.

The fastener boss 430 may include a bore 452 that extends through the snap assembly 428 along a central longitudinal axis 454. The bore 452 may bisect the locating pin 466 and is therefore circumscribed by the prongs 464. The mechanical fastener 432 may be inserted through the bore 452 of the fastener boss 430 for applying a clamping load across the assembly of the polymeric panel 420 and the separate structure 424. In this embodiment, the mechanical fastener 432 may be inserted through the passageway 474 of the top hat 470 of the separate structure 424 and then into the bore 452 for applying the clamping load. The top hat 470 is configured to increase the clamping loads that are capable of being applied across the assembly.

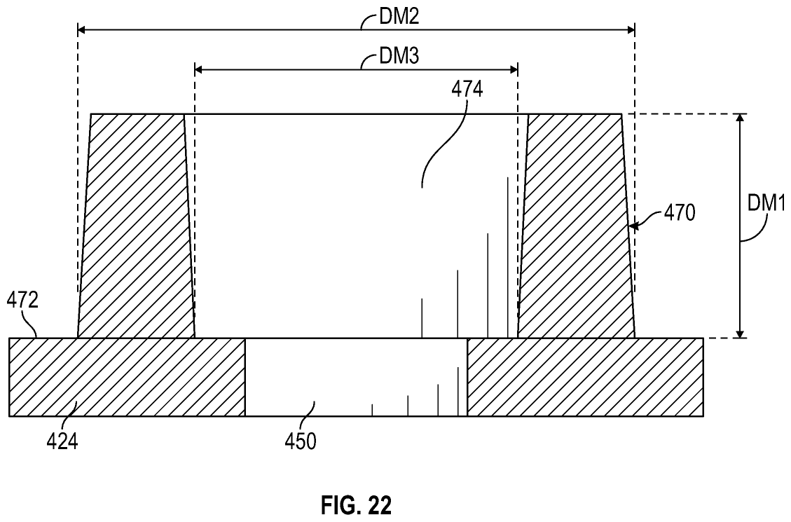

Referring now primarily to FIG. 22, various design characteristics associated with the top hat 470 may be scalable for accommodating varying sizes and shapes of the polymeric panel 420 and the separate structure 424. Various angles, dimensions, ratios, etc. associated with the features of the top hat 470 are described below. Again, these design characteristics are non-limiting examples of features of an exemplary retention assembly and are not intended to limit this disclosure. In this embodiment, the combined snap assembly and fastener boss 422 may include design characteristics that are either identical or substantially similar to the combined snap assembly and fastener boss 222 of FIG. 14.

The top hat 470 may extend a first dimension DM1 above the exterior surface 472 of the separate structure 424. In an embodiment, the first dimension DM1 is larger than the distance the prongs 464 extend from the exterior surface 426 of the polymeric panel 420. In another embodiment, the first dimension DM1 is at least 1 mm larger than the distance the prongs 464 extend from the exterior surface 426 of the polymeric panel 420.

A second dimension DM2 may extend between opposing sides of the top hat 470. The second dimension DM2 thus corresponds to an outermost diameter of the top hat 470 (here, near where the top hat 470 meets the exterior surface 472). In an embodiment, the second dimension DM2 is between about 115% and about 130% of a size of a washer 480 of the mechanical fastener 432. In another embodiment, the second dimension DM2 is about 125% of the size of the washer 480 of the mechanical fastener 432.

A third dimension DM3 may extend between opposing sides of the passageway 474 of the top hat 470. The third dimension DM3 thus corresponds to a diameter of the passageway 474. In an embodiment, the third dimension DM3 is greater than or equal to about 117% of the diameter of the opening 450 of the separate structure 424. In another embodiment, the third dimension DM3 is less than or equal to about 75% of the size of the washer 480.

The retention assemblies of this disclosure decrease the amount of packaging space required within certain vehicle assemblies in which both a snap and a mechanical fastener (e.g., bolt or screw) are required for mitigating motion and squeak between connected components. The retention assemblies are capable of controlling margins and flushness between the connected components while simplifying the overall assembly process. Mechanical fasteners can optionally be incorporated into the retention assemblies with no tooling impact, thereby providing significant cost savings.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A retention assembly, comprising:
a polymeric panel; and
a combined snap assembly and fastener boss formed in the polymeric panel.

2. The retention assembly as recited in claim 1, wherein the combined snap assembly and fastener boss is a molded-in feature of the polymeric panel.

3. The retention assembly as recited in claim 1, wherein the combined snap assembly and fastener boss protrudes outwardly from an exterior surface of the polymeric panel and includes both a snap assembly and a fastener boss.

4. The retention assembly as recited in claim 3, wherein the snap assembly includes a first arm, a second arm, and an open ended slot separating the first and second arms.

5. The retention assembly as recited in claim 4, wherein the first arm and the second arm cooperate to establish a two-way locator configured for locating a separate structure relative to the polymeric panel.

6. The retention assembly as recited in claim 4, wherein each of the first arm and the second arm include an interior surface and an exterior surface, and further wherein the exterior surface includes a first sloped wall, a second sloped wall extending at a transverse angle relative to the first sloped wall, and a lip disposed between the first sloped wall and the second sloped wall.

7. The retention assembly as recited in claim 4, wherein the fastener boss includes a bore that bisects the open ended slot near a midpoint of the snap assembly.

8. The retention assembly as recited in claim 7, wherein the bore is established by a first scallop formed in the first arm, a second scallop formed in the second arm, and the slot.

9. The retention assembly as recited in claim 3, wherein the snap assembly includes a plurality of spaced apart prongs that are arranged circumferentially relative to one another to establish a locating pin that protrudes from the exterior surface.

10. The retention assembly as recited in claim 9, wherein the fastener boss includes a bore that bisects the locating pin.

11. The retention assembly as recited in claim 9, wherein the locating pin is a four-way locator configured for locating a separate structure relative to the polymeric panel.

12. The retention assembly as recited in claim 9, wherein each of the plurality of spaced apart prongs includes an interior surface and an exterior surface, and further wherein the exterior surface includes a first sloped wall, a second sloped wall, and a lip disposed between the first sloped wall and the second sloped wall.

13. The retention assembly as recited in claim 1, wherein the retention assembly includes a top hat formed on a separate structure that is attachable to the polymeric panel via the combined snap assembly and fastener boss.

14. The retention assembly as recited in claim 1, comprising a mechanical fastener received within a bore of a fastener boss of the combined snap assembly and fastener boss.

15. The retention assembly as recited in claim 1, wherein the snap assembly of the combined snap assembly and fastener boss is received through an elongated slot or a circular hole formed in a separate structure that is attachable to the polymeric panel.

16. A vehicle assembly, comprising:
a first panel;
a separate structure connectable to the first panel;
a retention assembly configured to locate and connect the separate structure to the first panel,
wherein the retention assembly includes a combined snap assembly and fastener boss formed in the first panel.

17. The vehicle assembly as recited in claim 16, wherein the first panel is a polymeric panel and the separate structure is a polymeric or metallic structure.

18. The vehicle assembly as recited in claim 16, wherein the first panel and the combined snap assembly and fastener boss establish a unitary, integrally formed polymeric structure.

19. The vehicle assembly as recited in claim 16, wherein the retention assembly includes a mechanical fastener received within a bore of a fastener boss of the combined snap assembly and fastener boss.

20. The vehicle assembly as recited in claim 16, wherein the retention assembly includes a top hat formed on the separate structure.
